(19) United States
(12) Patent Application Publication
(10) Pub. No.: US 2015/0276394 A1
(43) Pub. Date: Oct. 1, 2015

(54) Method and algorithm to calculate the wave frequency (phase) changes by moving objects

(71) Applicants: Alexander Durandin, Massapequa, NY (US); Dennis Durandin, Massapequa, NY (US)

(72) Inventors: Alexander Durandin, Massapequa, NY (US); Dennis Durandin, Massapequa, NY (US)

(21) Appl. No.: 14/228,942

(22) Filed: Mar. 28, 2014

(51) Int. Cl. G01B 15/00; G01P 3/02; G01B 17/00; G01P 3/36

(52) U.S. Cl. CPC G01B 15/00; G01P 3/36; G01P 3/02; G01B 17/00

(57) ABSTRACT

The Doppler Effect method (1) is an approximation, which gives an accurate result only in the case of the collinear movement of the wave and the object. The use of the projection of the vector of an object's speed onto the direction of the wave propagation suggests constant speed of the object. The case, when the speed of the object changes, for example an orbital movement of the satellites is not even considered. The attempts to include the relativistic corrections (2) into the Doppler Effect method created an error even bigger in the case, when the wave emitter and the object move toward each other.

The Durandin method corrects these errors and improves the accuracy of the obtained information. It uses no approximation, instead it takes into account any possible changes of the object's speed value and direction and it does not need relativistic corrections.

In case of the time synchronization between the satellite and the ground station the Durandin method takes into account the length of the time interval needed for the frequency measurement. The Durandin method allows calculation of the actual position of the satellite, at the moment, when the value of the measured frequency is equal to the frequency emitted by the ground station and the time delay associated with that shift of the satellite position.

### BACKGROUND OF THE INVENTION

Soon after Doppler Effect discovery in 1842 (1) scientists started attempts to use wave measurements to detect objects in the fog. First measurements and first patents were based on continuous wave frequency measurements (4). In 1934 the first patent based on pulsed technique measurements was issued in the USA (3). Modern devices, such as GPS, radars, etc. use both pulsed technique and frequency change approach (5). For the stationary objects the pulsed method can provide distance to the object according to the formula D=c·Δt, where D—is distance, c—is the speed of the wave and Δt—is the time interval. In order to measure the speed of the object two or more distances should be measured over a specific time interval. For many cases the time of the measurements is too long and the resulting error prevents this method from successful implementation. If the object changes the speed or direction of its movement, this approach becomes useless. In GPS the best time measurements have an accuracy of approximately 100 nsec and produce a distance measurement accuracy of ΔD≧10⁻⁷·3·10⁸=30 m (5). It means that the initial error is 30 meters or more. Combining the data from several satellites and following several mathematical iterations, that error can be decreased down to several millimeters, but such procedure requires significant amount of time. The approach, known as the differential GPS, or DGPS (5), as well as the incorporation of the data from weather stations and cellular transmitters can improve the result down to several meters per several seconds. For the stationary radars and relatively small speeds, such an approach can produce satisfactory results. But a plane can change its position more than 300 meters in one second. This approach cannot produce speed measurements with any reasonable accuracy especially for aviation, marine, or military applications.

The measurements of the wave frequency (or phase) change with the current technology theoretically are supposed to produce accuracy of the position measurements down to 3 mm, or 10,000 times better than the pulse method. Unfortunately, in practice it is not true. But since there is no other way to measure the instant speed and acceleration of the object, both of these methods are used (5). The time and the position resolution of the modern GPS could be considered satisfactory for city traffic, but not for marine, aviation or military application. Taking into account the absence of the cellular network in the oceans, it is clear that the error in the case of the fast boats somewhere in the ocean away from their ports will also be large.

The measurements of the frequency or phase shift of the wave and the calculations of the speed and the position of the object are currently performed according to the Doppler Effect formula

$${f}_{obs} = ( 1 \pm \frac{v \cdot cos θ}{c} ) \cdot {f}_{0} .$$

These types of measurements are supposed to produce more accurate results, but the experiments show that this is not true. Attempts to incorporate Einstein's relativistic corrections in the form of

$${f}_{obs} = ( 1 \pm \frac{v \cdot cos θ}{c} ) \cdot \frac{{f}_{0}}{\sqrt{1 - \frac{{v}^{2}}{{c}^{2}}}}$$

did not improve the accuracy of that approach.

### SUMMARY OF THE INVENTION

The Durandin method is based on the principle of the independence of the initial distance between the wave emitter and the moving object from the speed of the object and from the angle between the speed of the object and the direction of the wave propagation, while the Doppler Effect method is based on the projection of the speed vector of an object onto the direction of the wave propagation. The Durandin method produces a different result for the wave frequency and phase changes for the non-collinear movement of the wave and the object.

In the Durandin method the frequency change should be calculated according to the formula

$${f}_{obs} = {f}_{0} \cdot \sqrt{1 + \frac{{v}^{2}}{{c}^{2}} - 2 \frac{v}{c} cos δ}$$

for the system of coordinates associated with the wave emitter. For the GPS, when the satellites with the wave emitters are moving, the appropriate coordinates' transformations should be taken into account. Transformations also should be done for any measurements, where the wave emitter is moving, like the radar on the plane.

The definition of the angle δ in the Durandin method is different from the angle θ in the Doppler Effect method.

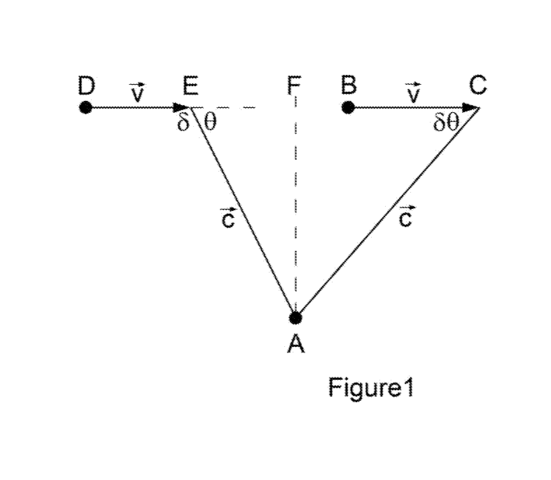

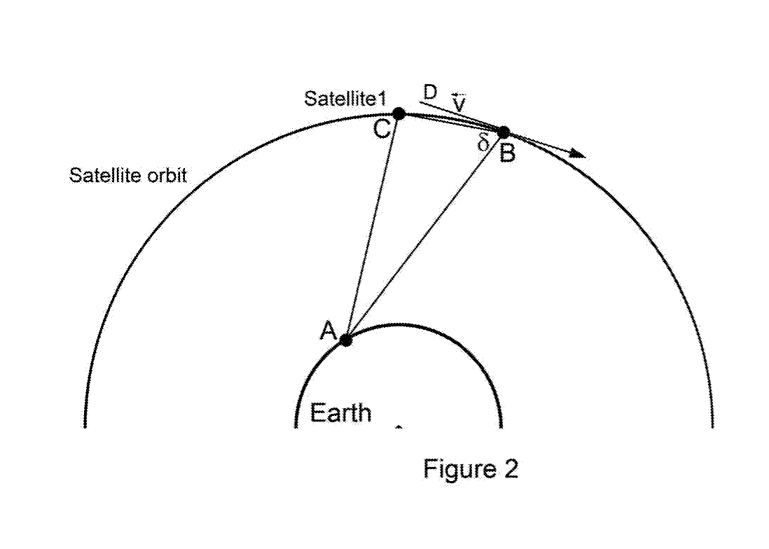

There are actually two important points of difference between these angles.
1. In FIG. 1 the stationary position of the emitter is marked with the letter A. The object, moving with the constant speed from the point B to the point C illustrates the case, when the distance between the wave emitter and the object increases. The angle δ in the Durandin method and the angle θ of the Doppler Effect method in that case are the same. The object, moving from the point D to the point E illustrates the case, when the distance between the wave emitter and the object decreases. In this case the difference between the angles θ of the Doppler Effect method (FIG. 1a) and the angle δ in the Durandin method is illustrated on FIG. 1. These are the cases of the linear movement of the object without acceleration.
2. In the case of GPS, the movement of the satellite cannot be described as linear movement with constant speed. Orbital movement has constant acceleration and the difference between straight line and the orbital curve cannot be neglected. The Durandin method for wave frequency changes takes into account the integral of the non-linear object movement and as a result the definition of the angle δ is different from the Doppler method as illustrated in FIG. 2. In FIG. 2 the angle θ of the Doppler Effect method is equal to the ABD, where AB is the direction of the wave propagation and the DB is the vector of the satellite speed. The angle δ of the Durandin method does not form an angle ABD, but rather it forms an angle ABC, created by the direction of the wave propagation and the line CB, which connects the positions of the satellite at the moments of the wave emission and the wave reception. This approach includes integration of the path of the object, moving with any arbitrary acceleration. As a result we obtain an average speed and the direction of non-linear movements of an object over the time interval.

The GPS satellite was used as an illustration of the difference between the Doppler and the Durandin methods. The same approach can be used for a plane during evasion maneuver, or other objects, moving with acceleration, taking into account appropriate coordinates transformations.

If both the wave emitter and the object move along the same line, then cos θ=−1, when the direction of the movement is away from each other and cos θ=1, when the direction of the movement is toward each other. The Durandin formula brings us back to the Doppler formulas

$${f}_{obs} = {f}_{0} \cdot ( 1 \pm \frac{v}{c} )$$

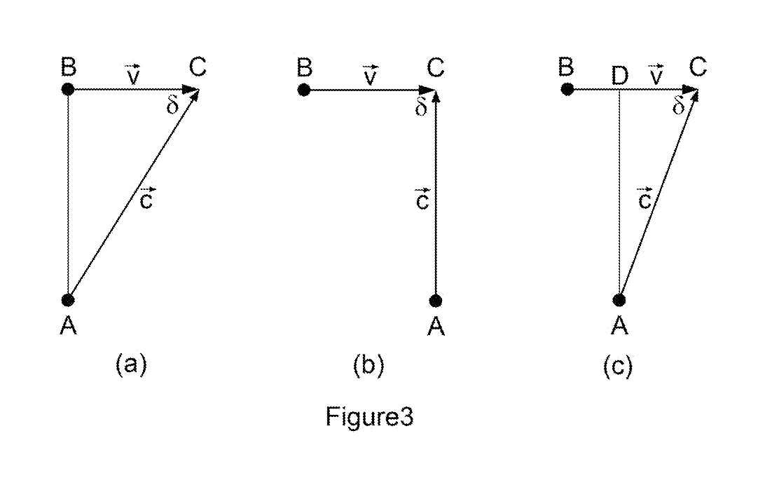

for the collinear movement. In all other cases the formulas for the Durandin method are different from the Doppler Effect formulas. FIG. 3 illustrates several specific cases.

In case of FIG. 3a the simplified formula is

$${f}_{obs} = {f}_{0} \cdot \sqrt{1 - \frac{{v}^{2}}{{c}^{2}}} .$$

For the case of the FIG. 3b the simplified formula is

$${f}_{obs} = {f}_{0} \cdot \sqrt{1 + \frac{{v}^{2}}{{c}^{2}}} .$$

The FIG. 3c represent the case, where the frequency decreases between points B and C. Between points B and D the observed frequency is higher, than emitted frequency f_{obs}≧f₀ and between points D and C the observed frequency is lower, than emitted frequency f_{obs}≦f₀. The resulting frequency can be calculated as a sum of frequency higher than f₀ between the points B and D and the frequency lower, than f₀ between the points D and C. The difference in the time of travel between the wave and the object in the case of the orthogonal directions cannot be neglected and the Durandin formula

$${f}_{obs} = {f}_{0} \cdot \sqrt{1 + \frac{{v}^{2}}{{c}^{2}} - 2 \frac{v}{c} cos δ}$$

should be used. This case has special importance for the time synchronization between the satellite and the ground station, because of minimum distortions from ionosphere and troposphere, when the wave propagates in the orthogonal direction. Durandin method shows that the position of the satellite, when the observed frequency is equal f=f₀ or has closest value to the emitted frequency is shifted from perpendicular position (on the radius) along the direction of the satellite movement and that shift can be calculated from the Durandin method.

Advantages (improvements) of the Durandin method over existing methods are as follow:

1. The Durandin method and algorithm are more accurate and they substitute Doppler Effect method and algorithm.
2. The Durandin method does not need any relativistic corrections for speed, distance and time.
2. The Durandin method produces accurate results for curved trajectories of the object movements as well as the movements with a positive or negative acceleration. This feature is essential for GPS systems, where satellites move with rotational acceleration. The changes in two or more frequencies of the emitted waves produce the relative speed of the wave emitter and the moving object as well as the angle δ.
3. The frequency measurements can be used for more accurate time synchronization, than with the time synchronization with an atomic clock.
4. The measurements of the phase and frequency changes at the doubled frequency produce an instant value for the acceleration of the object. These include any changes in the direction of the objects movements. The straight measurements of the derivative of the signal are always more accurate than the measurements of the signal and the subsequent differentiation of the signal.
5. The combination of the Durandin method and the pulsed method can produce (approximately 1000 times) more accurate time synchronization than the currently available methods.

### PUBLICATIONS

1. Doppler, C. J. (1842). Ueber das farbige Licht der Doppelsterne and einiger anderer Gestirne des Himmels (About the coloured light of the binary stars and some other stars of the heavens). Publisher: Abhandlungen der Königl. Böhm. Gesellschaft der Wissenschaften (V. Folge, Bd. 2, S. 465-482) [Proceedings of the Royal Bohemian Society of Sciences (Part V, Vol 2)]; Prague: 1842 (Reissued 1903).
2. Einstein, Albert (1905). “Zur Elektrodynamik bewegter Körper”. Annalen der Physik 322 (10): 891-921.Bibcode:1905AnP . . . 322 . . . 891E.doi:10.1002/andp.19053221004. English translation: ‘On the Electrodynamics of Moving Bodies’.
3. Page, Robert Morris, The Origin of Radar, Doubleday Anchor, New York, 1962, p. 66.

### US PATENT DOCUMENTS

4. Patent DE165546; Verfahren, um metallische Gegenstände mittels elektrischer Wellen einern Beobachter zu melden.

5. U.S. Pat. No. 6,469,663 B1; Oct. 22, 2002. Method and system for GPS and WAAS carrier phase measurements for relative positioning.

### DRAWINGS

1. FIG. 1. The difference between the angle δ in the Durandin method and the angle θ in the Doppler Effect method for the linear movement of an object.

2. FIG. 2. The difference between the angle δ in the Durandin method and the angle θ in the Doppler Effect method for the non-linear (accelerated curved) movement of an object.

3. FIG. 3(a,b,c). Illustration for the several specific cases of the orthogonal direction of the speed of an object and the direction of the wave propagation.

1. The Durandin method and (or) algorithm (mathematical or computer) for calculations of the waves frequency and phase changes as a result of the movement of the object relative to the wave emitter for obtaining any information about object, such as object's speed, position, acceleration, shape, structure, etc. The wave definition includes, but not limited to electromagnetic, acoustic and other waves. The waves can be in vacuum, air, water or any other media. The Durandin method, applied to the electromagnetic and acoustic wave systems, where corrections according to the Durandin method
$${f}_{obs} = {f}_{0} \cdot \sqrt{1 + \frac{{v}^{2}}{{c}^{2}} - 2 \frac{v}{c} cos δ}$$
are provided for errors, which would otherwise occur, because of a frequency and (or) phase shift in a wave due to relative movement between the wave source and receiver.

2. Apparatus, techniques and devices, which utilize or based on the Durandin method for obtaining information about objects speed, position, size as well as for time synchronization between separated in space objects such as satellites, ground stations, planes, ships, missiles and other moving objects. Such apparatus include, but are not limited to GPS, radars, underwater radars, communication systems, echocardiographs, ultrasound imagers, fetal monitors; also devices where the waves produced by any source of the coherent radiation, such as laser velocimeters, laser distance meters, laser altitude meters, vibrometers, flow meters, lidars, weather radars, sonars, imaging devices as well accelerators.

3. The Durandin method or algorithm (mathematical or computer) for time synchronization between separated in space objects. Examples of such objects are satellites, ground stations, planes, ships, missiles and others.
